(19) United States
(12) Patent Application Publication
(10) Pub. No.: US 2002/0110495 A1
(43) Pub. Date: Aug. 15, 2002

(54) Devices and methods for purification

(76) Inventors: Denis Hunt, Acton, MA (US); Michael D. Brownleader, Windsor (GB)

Correspondence Address: John F. Perullo, Kirkpatrick & Lockhart LLP, 75 State Street, Boston, MA, 02109-1808, US

(21) Appl. No.: 10/041,912

(22) Filed: Jan. 7, 2002

Related U.S. Application Data
(60) Provisional application No. 60/260,136, filed on Jan. 5, 2001.
(60) Provisional application No. 60/269,977, filed on Feb. 20, 2001.
(60) Provisional application No. 60/284,579, filed on Apr. 18, 2001.
(60) Provisional application No. 60/337,708, filed on Dec. 7, 2001.

(51) Int. Cl. G01N 1/28

(52) U.S. Cl. 422/101; 436/177; 436/178

(57) ABSTRACT

The present invention provides a device and method for the purification and separation of substances. The purification device comprises a sample holder comprising a sample chamber and a column module. The column module is securable to the sample holder and is packed with chromatography medium having a special affinity for attracting a given substance. A variety of mediums can be used in the capsule of the purification device, each containing different medium types. The column modules may be prepacked by the manufacturer or may be provided empty so that a user defined medium may be inserted into the capsule by the user. With the column module and sample loaded, pressure may be applied to move the sample through the module to by means such as centrifuging in order to separate the selected substance from the sample.

### FIELD OF THE INVENTION

This invention relates to devices and methods for the separation of substances from liquid or liquid-containing materials. It relates particularly although not exclusively to laboratory-scale separations. Embodiments of the invention relate particularly to separations which amount to purification of one or more substances in the material to be processed.

### BACKGROUND OF THE INVENTION

A variety of devices are available to the laboratory worker to assist in the concentration, separation and purification of chemical, biochemical and microbiological products. The various devices and apparatus available exploit the well-known techniques of filtration, micro filtration, chromatography and centrifugation, each with a range of possible refinements and modifications.

Chromatography is the optimum technique for proper purification. Laboratory chromatography columns are used in a wide range of sizes and with a wide range of chromatography media according to the materials being worked with. Ion-exchange media for example are used for small-scale purifications of nucleic acids and affinity media is commonly used to purify antibodies. The chosen medium is usually loaded directly into a small column for use. Preloaded columns are also available and may be adapted to connect to a flow driver e.g. a pump or vacuum line.

In the fields of filtration and ultrafiltration, both inert and active filter membranes are available for use. One product available is a cylindrical tube with an ion-exchange microporous membrane trapped on a perforated base of the tube. The tube fits onto a centrifuge tube so that it can be spun to speed the separation process.

### SUMMARY OF THE INVENTION

An object of the invention is to enlarge the repertoire of purification devices and techniques available to the skilled worker, in view of the wide variety of technical demands and preferences, particularly in the biochemical and microbiological fields.

Another object of the invention is to provide devices and methods that achieve high-quality separations or purifications rapidly while preserving reliability.

Another object of the invention is to provide devices and methods that enable skilled persons such as researchers to carry out multi-step preparations and purifications with the greatest convenience in arranging apparatus and materials, using a modest range of compatible equipment.

Another object of the invention is to provide a purification system configured to have interchangeable medium columns and to provide a kit that facilitates changing of the medium columns.

Another object of the invention is to provide a purification system that optimises filtration by properly directing flow of a sample through a chromatography bed during centrifuging.

In view of the foregoing, the present invention provides a purification device comprising:

(a) a sample holder, the sample holder having an upper part defining a sample chamber for holding a liquid sample and a lower part defining a column insert portion with an opening communicating with the sample chamber, and

(b) a discrete column module comprising a capsule having upper and lower permeable walls, and a bed of separation medium contained in the capsule between the upper and lower permeable walls;

the column module being securable in the column insert portion at the opening of the sample holder's lower part so that a purification path is defined leading from the sample chamber through the upper permeable wall of the capsule, the bed of separation medium and the lower permeable wall of the capsule.

By providing a chromatographic bed as a separate or separable element in the device, it becomes possible to provide a kit of multiple column modules as described, containing different mediums, e.g. particulate medium or membranes, each suitable for purification of a different substance and all adapted to be securably positioned at the opening of the sample holder. Such a kit is considered a further aspect of the invention. The kit may consist entirely of various column modules. However, the kit may also include one or more sample holders to which the column modules are connectable. The kit may also provide an insertion/removal tool to facilitate inserting and removing a column module from the column insert. Also to help facilitate processing of the separated substance the correct buffers may be provided. Additional centrifuge tubes and ultrafiltration spinners may also be provided.

The above described device and kit provides additional flexibility, convenience and speed in carrying out separations with plural stages of purification. The same apparatus can be used for more than one stage by interchanging one column module for another as appropriate. Since a range of different kinds of pre-packed chromatography mediums can be provided in the column modules, there is potentially a great gain in speed and convenience in separation processes.

The pre-packed column modules are themselves an aspect of the invention. Media for the column bed may be selected from the full range of media available. Thus, a kit of column modules may be packed with one or more different resins.

Different column modules in a kit also may differ in containing different bed volumes, while being securable to the same sample holder. The bed need not necessarily be a bed of discrete solid particulates. Other bed types may be used e.g. in line with conventional variants. One possibility is for the bed to comprise a stack of membranes, e.g. IEX filter membranes. Also, a membrane may be rolled to form a bed coaxial with the column module.

Alternatively, a user definable column module may be provided in place of, or in addition to the prepacked column modules discussed above. The user definable column module is an empty capsule that permits end users to supply their own customized column bed within the column module, which may then be used in the separation system. The column module may be provided with removable top and bottom membranes, which the user may remove to, either replace with membranes of differing porosity or may remove to install a specially prepared media to form the column bed within the module. The specific arrangement of filter medium and membranes is defined by the user to best achieve the separation objective. However, the user customizable column module still provides benefits shared with the above embodiments of a standardized capsule format that can be easily inserted into the sample holder in an integrated fashion with the rest of the separation system.

In a further aspect of the present invention the medium in the column module may be held under compression, i.e. packed. In conventional spin columns the medium is usually loaded dry and not compressed into a compacted state. Loading technique has a significant effect on the quality of separation achieved. With the present invention it is proposed to make the column modules by providing separate upper and lower parts thereof, each having a respective permeable wall portion. One of the parts having a containment portion with walls at least as high as and preferably higher than the desired bed to be formed. The other capsule part fits into a mouth of the first part, similar to a piston in a cylinder. In manufacture, a slurry of the particulate medium in an appropriate liquid is dosed into the containment portion of the module, the other part is inserted and the two are forced together to compress the bed of material between the upper and lower permeable walls. The slurry liquid of the material drains away. The capsule portions are adapted then to engage or to be fixed to one another sufficiently securely, by adhesive, bonding or interlock mechanism, to retain the bed in the compressed condition.

In another embodiment of the column module, a flow regulator additionally may be provided. A column module with a flow regulator may be desirable in instances in which a slower flow rate of the sample through the chromatography medium of the column module improves the filtration process. In some situations slowing the flow rate helps the fluid in the module and the attracting components of the filtrate bind together. The flow regulator may comprise an additional filtering membrane, such as a micro-porous membrane or an ultrafiltration membrane positioned along the flow path of sample material through the column module.

Preferably, the purification device is provided in a centrifugable configuration. A centrifuge offers the ability to pass a sample very rapidly through the column, collecting the eluate in a centrifuge tube positioned underneath the outlet from the column of the purification device. In one embodiment, the purification device fits into the mouth of a centrifuge tube and engages it to limit its insertion and thereby maintain a clearance beneath it in the tube to provide a collection volume. The collecting tube may be a standard centrifuge tube.

Another feature of the purification device is that the flow cross-section through the bed in the column module is less than the cross-section of the sample chamber. The cross-sectional area of the column bed is generally not more than 50%, and may be as little as about 20% of the corresponding (i.e. parallel) cross-sectional area in the sample chamber. The convergent transition from the sample chamber to the smaller cross-section to the column modulate helps to force the sample more completely through the medium bed during centrifuging.

The cross-section of the bed may be uniform along its length. Generally the bed will have a substantial depth in relation to its cross-section. The length of the bed in its flow direction may be approximately at least 50% to 200% of its maximum lateral dimension. The cross-sectional shape of the bed is not critical but for practical reasons a cylindrical bed is normally preferred. The bed may be co-axially arranged with the sample chamber by being placed in the column insert portion of the sample holder so that the opening to the bed coincides with the outlet of the sample chamber.

The column modules may be attachable at the sample holder outlet in any of various ways, provided that the attachment assures that essentially all samples passing from the chamber passes through the bed. In one configuration the sample holder has column insert portion configured as a tubular extension at the outlet of the sample chamber into which the column module is slidably received in a close fit. The column module becomes secured with the sample holder to prevent its escape from the tubular extension. The engagement between the column module and sample holder might be, for example, a snap engagement between sliding surfaces of the two, or one or more laterally-projecting lugs, flanges or shoulders on one of the components providing a limit stop preventing passage of the other component past a predetermined position. The engagement may or may not be releasable to enable re-use. In an illustrative embodiment, provided is a limit stop preventing the column module from passing downwardly out of the sample holder outlet extension, the column module being inserted into the sample holder from above via the sample chamber and removable through the same path.

In an illustrative embodiment the column module capsule comprises an impermeable tubular (preferably cylindrical) side wall with permeable upper and lower end walls, which allow liquid but not the particulate separation medium to pass through. The end walls may be conventional frits or sinters. They may be held in position in the capsule by being fixed to the side wall e.g. by bonding or mechanical engagement. Preferably, the end walls are mechanically retained by detent engagements made with corresponding formations of the side wall e.g. inward end flanges. The upper and/lower walls of the capsule may include support portions to support the permeable wall especially towards its centre. Any of these modes of construction may be used in the version of the module mentioned above, involving pre-compression of the bed.

The volume of the sample chamber is not limited but is typically in a range appropriate for analytical, preparative or semi-preparative work in the laboratory. Sample chamber volumes in the range 100 μl to 250 ml may be appropriate. The volume of the bed in the column module may be approximately at least 0.5%-2% of the volume of the sample chamber. For certain specialised uses the sample chamber might be as small as 50:I of the range mentioned above and the bed volume perhaps down to 5 or 10:I. Preferably, the bed volume is not more than 25% of the volume of the sample chamber.

The purification devices described above are suitable for use in purification under various flow regimes, e.g. under gravity feed, applied pressure head, vacuum applied at the outlet, peristaltic pumping or centrifugation. However, particular features disclosed herein are especially suitable for centrifugal separation and represents another aspect of the invention as described below.

The wall of the sample holder may have a non-perpendicular convergence i.e. a taper leading from the larger cross-section upper part (sample chamber to the smaller cross-section to the lower part cylindrical extension. The taper helps to avoid trapping residues of sample especially when the flow impetus may not be parallel with the flow axis e.g. in a centrifuge. The taper helps to direct the sample flow into the column module across its entire cross-section for more efficient separation during centrifuging. The angled interior surface provided by the taper directs flow into the column module. Without the taper, flow is not focused and one side of the chromatography bed could be overloaded during centrifuging with a flow impetus applied away from the flow path axis of the sample holder. Overloading of the chromatography bed in one concentrated area of its cross-section causes inefficient separation of the sample.

The reduced cross-section of the column portion as compared to the sample chamber portion of the sample holder also increases efficiency of the purification system over previous systems. It is known in the art to separate a sample using a microporous ion-exchange membrane, in a tubular holder in a centrifuge. However, with this arrangement difficulties may arise in distribution of the sample over the membrane under centrifuge conditions, leading to inhomogeneities. This uneven sample application caused by the centrifuge conditions would be expected to make the technique useless, or at best low quality, with a particulate bed where there is a risk of break-through of the sample.

In the present invention the flow cross-section through the column bed is substantially smaller than the cross-section of the sample chamber above. A liquid or liquid-containing sample is put into the sample chamber of the purification device comprising a sample holder with an upper part defining the sample chamber, an outlet which communicates with the chamber and a column insert portion that incorporates a bed retained between upper and lower permeable walls. A purification path is defined leading from the sample chamber through the upper permeable wall, the bed of particulate separation medium and through the lower permeable wall. Relative cross-sectional areas, shape and aspect ratio of the column, the volumes and relative volumes of the sample chamber and bed may be as with previous embodiments. In use, the device is centrifuged to pass the liquid of the sample through the column for purification, catching the eluate in a collection chamber beneath.

By reducing the cross-sectional area of the column relative to the sample chamber, the relative unevenness in application of the sample to the bed (arising from lateral tendencies and movements of the sample) is reduced or avoided. In conventional devices, such unevenness might result for example from the sample lying to the side of the chamber when a fixed-angle centrifuge is used, or moving around in the chamber when a variable-angle mounting is used. According to the degree to which the bed area is less than the sample area, the top surface of the bed “samples” only a minor portion of the body of the sample and is less susceptible to gross variations in the application of sample over its area. Because a bed is used, sufficient active media area for the sample volume can be assured by making the bed deeper. In this aspect the provision of the column as a discrete module is only a preferred option, not an essential feature.

A further aspect of the invention is a device comprising two or more sample holders of any appropriate kind as described previously, joined together in an array. This may be a two-dimensional array such as a well plate, each of a plurality of these sample holders (and preferably all of them) having an outlet connector for a discrete column module, which may be as described previously. As in a conventional well plate the sample holder array may be a one-piece moulded plastic entity. The column modules are preferably insertable into their connectors through the sample chambers. The number of sample holders in the array is not particularly limited, but for use with current conventional systems an array size of 8, 96 or 384 may be employed.

The array of sample holders may be positioned over a collector, which has collection vessels aligned with the outlets leading from the sample holders via the column modules. These vessels receive the filtrates or eluates from the respective column modules. The collector array may be a tray, e.g. a one-piece plastic tray, shaped with recesses to provide an array of collection vessels corresponding with the sample holders of the sample holder array.

The sample holder array and/or the collection vessel array may have a barrier masking or isolating the path between one sample holder/collector pair from that between one or more neighbouring pairs. This helps to prevent cross-contamination if the apparatus is moved. For example, the outlets of the sample holders/columns may overlap axially with the opening surrounds of the collection vessels. Or, these outlets and openings may engage one another. In an illustrative embodiment each collector vessel has an inward overhang of its surrounding wall to help retain its contents, and the outlet from the sample holder/column may contact the overhang adjacent the opening. A seal element may be provided interposed between the arrays of outlets and vessels, with openings through the seal element in register with the sample outlets and collector openings, and making sealing contact with both.

The well plate arrangement may be used with small-scale multiple analyses and preparations, for example proteomics (the digestion of proteins to small oligopeptide and amino acid fragments, usually as a preliminary to mass spectrometry). The device also may be used with protein purifications, protein separations and screening or with any biological and/or charged molecules. For non-DNA uses a bed need not be used; the use of a membrane e.g. IEX membrane is also possible. Another use for the devices disclosed herein is in any one or more of the desalting, washing and concentration of peptide digests as a preliminary to mass spectrometry.

The sample and bed volume may be very small for applications such as these in comparison to the volumes discussed above in previous embodiments e.g. down to 25 or down to 50:I for the sample chamber and down to 1, 5 or 10:I for the bed volume. A small bed volume can minimise non-specific absorptive losses, which can be significant for the tiny (sometimes femtomolar) samples handled in these techniques.

In the array embodiment, an array of column modules is preferably preloaded into the sample holder array for commercial use. Similar sample holders may be available preloaded with a variety of different media. In order to protect the media, a preferred construction provides a removable protective cover over at least the top openings and possibly also over the outlet openings of the sample holders. For example, the protective cover may be a peelable polymer film or laminate. Such a removable cover may be subdivided with prepared lines of weakness, e.g. perforated lines, enabling it to be peeled away from a predetermined part of the array leaving another part covered e.g. for use later.

In this aspect it may be possible to dispense with the discrete modules and instead load the medium columns directly into the bottoms of the sample well holders. Such loading may be accomplished by first installing lower permeable retaining walls in the sample well holders, followed by loading the media and then fixing in top permeable retaining walls. As before, the purification path through the bed may be cross-sectionally smaller than the sample holder.

Another feature of the array embodiment that is particularly suited to implementation in a multiwell format, relates to a procedure for protein digestion (in gel or in solution). The digestion of the protein with the appropriate protease(s) e.g. trypsin, is done in the sample chamber above a separation bed or membrane layer. By reducing material transfer, especially with a low bed volume or membrane area as described elsewhere, this can reduce absorptive losses and improve recovery of peptides from the digest.

A further aspect of the invention concerns pipette tips, i.e. the disposable plastic tubes of predetermined volume that fit to automatic or manual pipetting machines and which have tapered nozzles. Currently small pipette tips are available that hold a small polymer-stabilised charge of reverse-phase silica chromatography medium in the extreme end of the pipette tip, next to the nozzle opening. These are used for desalting and concentrating peptides before mass spectroscopy. The present invention may be configured with a pipette tip adapter comprising a discrete column module preloaded with chromatography medium or membrane(s) and shaped to fit onto or into a pipette tip which has a convergent nozzle, and preferably onto or into the convergent part thereof. This pipette tip adapter may have a casing or shell portion shaped to complement the inner or outer surface as appropriate of a pipette tip in a plug or socket fashion respectively, forming an essentially liquid-tight joint. The joint may be created by a frictional fit, so that the adaptor can simply be pushed into place on/in the pipette tip. Since pipette tips are usually convergent both inside and out, at least near the nozzle opening, this adaptor shell portion may therefore have a tapering or conical inner or outer surface which tapers at an acute angle to an axis of the adaptor, e.g. at between 2 and 10 degrees to that axis. The adaptor may comprise or consist of a conical tubular element, optionally with upper and/or lower permeable retaining elements to hold in place between them a bed of chromatographic material or membrane(s). This bed may be of any of the kinds previously discussed herein, as may be the permeable retaining walls where present. The adaptors may be used with any size of pipette tip, e.g. from 10 μl to 10 ml or 20 ml pipette tip volume.

For an insert adaptor, which fits inside the pipette tip, the entire capsule may be occupied by the bed. Furthermore, since the pipette tip wall will retain liquid it is not critical whether the capsule wall is permeable. Thus, such an insert element may have a capsule consisting of permeable e.g. sinter material. An external adaptor may have a capsule portion containing a bed as forementioned, with a conical extension diverging from one end, which fits over the end of the corresponding pipette tip to hold the capsule in place. The capsule wall may be of any suitable impermeable plastics material. As mentioned, top and/or bottom permeable retaining walls may or may not be used.

The dimensions and volumes of the adaptors and their beds depend on the size of the corresponding pipette tip. Generally, the bed volume is likely to be between 0.5 and 100:I of the pipette volume. Alternatively or additionally, the bed volume will usually be at least 1% and preferably at least 2% of the actual or nominal volume of the pipette tip, to which it fits. Conversely, the bed volume would normally be not more than 20% of that volume.

A kit comprising one or more pipette tip adaptors of the kind described containing different kinds of media and/or membranes in conjunction with pipette tips which they fit, is a further aspect protected herein. A pipetting method in which an adaptor as described is fitted onto or into a pipette tip is a still further aspect of the invention.

### BRIEF DESCRIPTION OF THE DRAWINGS

The foregoing and other objects and advantages of the invention will be appreciated more fully from the following further description thereof, with reference to the accompanying diagrammatic drawings wherein:

FIG. 1 is an axial cross-section of a sample holder;

FIG. 2 is an axial cross-section, enlarged relative to FIG. 1, of a column module;

FIG. 3 is an axial cross-section showing the column module fitted into the sample holder of FIG. 1 and with a cap fitted;

FIG. 4 shows the assembled sample holder and column module fitted into a centrifuge collection tube; and

FIGS. 4A and 4B are illustrations of sample holders in a centrifuge position;

FIGS. 5 and 6 are axial cross-sections enlarged relative to the preceding figures, showing stages of preparation of a column module;

FIGS. 6A through 6E show column module embodiments with a capsule incorporating a flow regulator;

FIG. 7 is a vertical cross-section through a multiwell plate and collector tray;

FIG. 8 shows the plate and tray of FIG. 7 modified with an intervening seal;

FIG. 9 is an axial cross-section of a modified pipette tip with a column module adaptor, and

FIG. 10 is an axial cross-section showing a different version of modified pipette tip;

FIG. 11 shows a purification device kit.

### DESCRIPTION OF ILLUSTRATIVE EMBODIMENTS

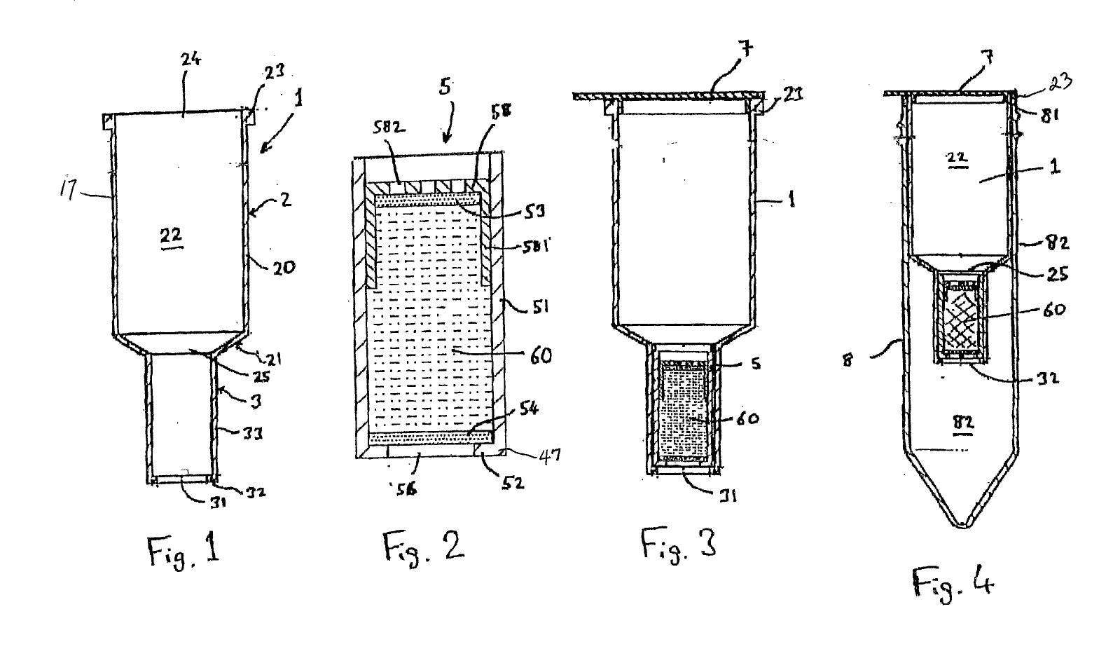

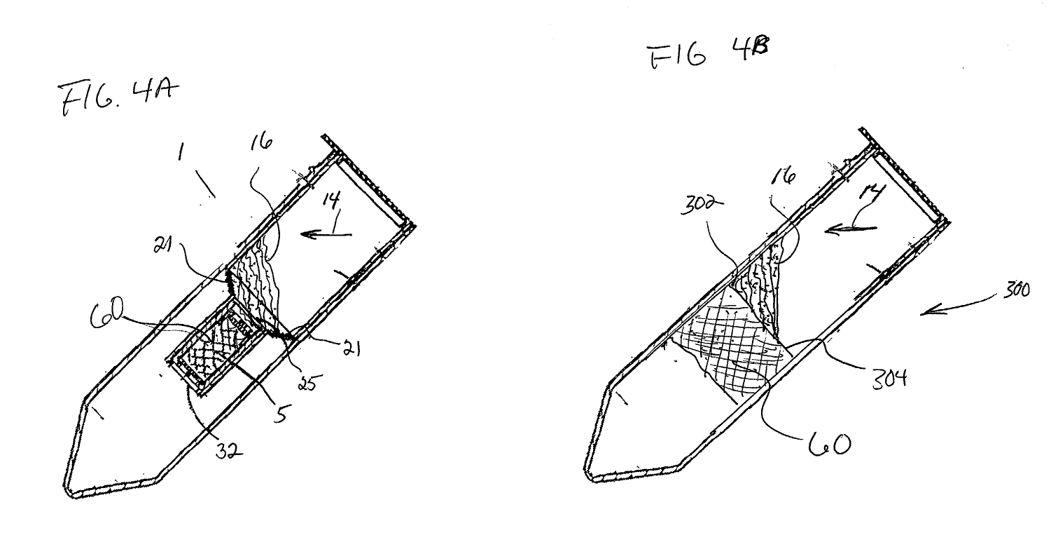

A purification device embodying the invention is shown in FIGS. 1 to 3. Its major components are a sample holder 1 and a column module 5 which is shown enlarged in FIG. 2 and which is insertable into the sample holder 1 as shown in FIG. 3. FIG. 3 also shows a cap 7 for the sample holder 1.

Referring to FIG. 1, the sample holder 1 is a generally cylindrical one-piece component that may be injection-moulded from conventional plastic materials e.g. polypropylene. Its has a continuous side wall 17, which has a cylindrical upper part 20 of larger diameter with a circular top opening 24, an intermediate convergent portion 21 that forms a transition to a lower portion defining a column insert portion 3 having a lower cylindrical extension 33 with an outlet opening 31 at its base.

The diameter of the column insert portion 3 is about half that of the upper portion 2. The upper portion 2 defines a sample chamber 22 open upwardly through the wide top opening 24 and downwardly via convergence 21 through a sample chamber outlet opening 25 into the column insert portion 3. As an example of dimensions, the upper portion 2 may have a diameter of 25 mm and an axial length of 44 mm, giving an effective volume of about 20 ml for the sample chamber 22. The lower cylindrical extension 33 may have a diameter of 12 mm and a length of 26 mm i.e. enclosing a volume of about 3 ml.

At a bottom edge of the column insert portion 3 may be formed an integral inturned flange 32 for retaining a column module 5 that is slidably received in the lower part 3. The column module 5 consists of a cylindrical capsule 51, which is a close fit in the column insert portion 3 of the sample holder. The capsule 5 can be put into the sample holder 1 from above, and drops down into the cylindrical extension 3 until stopped by the bottom flange 32.

Like the sample holder, the wall 51 of the cylindrical capsule 5 may be injection-moulded from transparent plastics material. The capsule wall 51 has a bottom edge 52, which is inturned to form a support flange 47 with one or more central opening slots 56. Lining the bottom of the capsule and resting on the support flange 52 is a lower permeable wall 54 made from a conventional plastic sinter or frit. A packed bed 60 of particulate chromatography medium fills the capsule interior, resting on the lower permeable wall 54. A top closure 58 has a cylindrical side wall 581 sized to create a tight fit with the main capsule side wall 51, a top wall having a set of openings 582 and an upper permeable wall 53 which may be of similar material to the lower permeable wall 54 and is backed by the top wall with the openings 582. This upper closure 58 is force-fitted down into the main capsule wall 51 and holds the particulate bed 60 in compression between the upper and lower permeable walls 53, 54.

In the example shown the packed bed is about twice as long axially as it is wide. However because of the sliding fit of the top closure 58 the aspect ratio of the bed can be modified without changing the components simply by changing the amount of medium in the bed 60.

As seen in FIG. 3, when the capsule 5 is fitted into the holder 1 it occupies the lower tubular extension 3 of the holder 1 so that sample leaving the sample chamber 22 via its lower opening 25 must pass in turn through the top wall openings 582, the top permeable wall 53, the packed bed 60 in which chromatographic separation takes place, the lower permeable wall 54 and out through the bottom wall opening(s) 56.

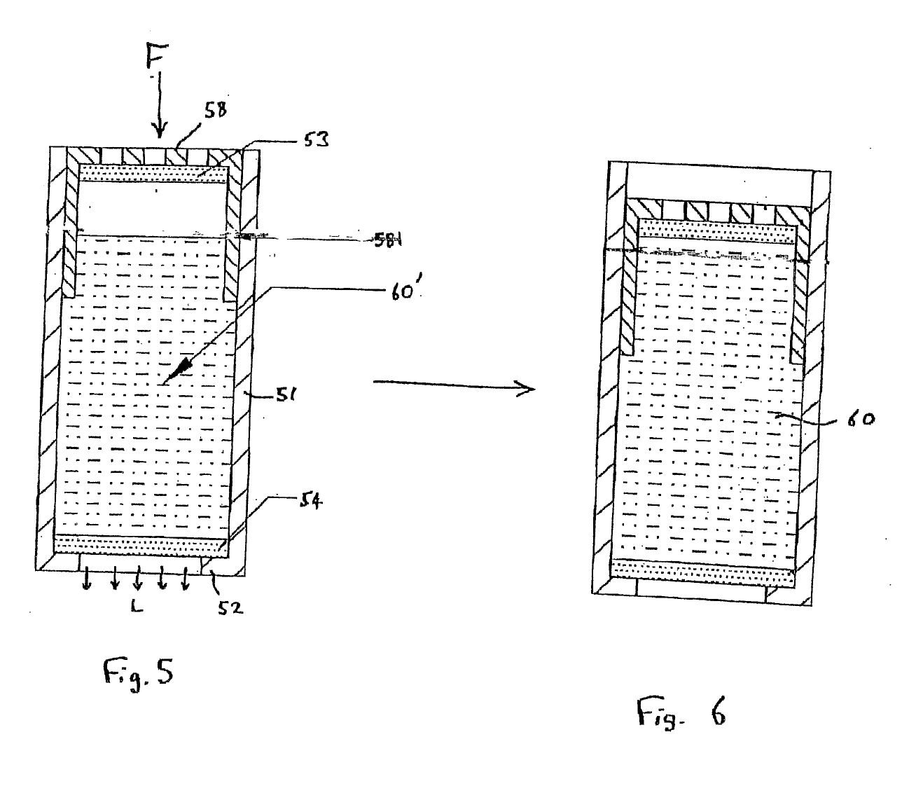

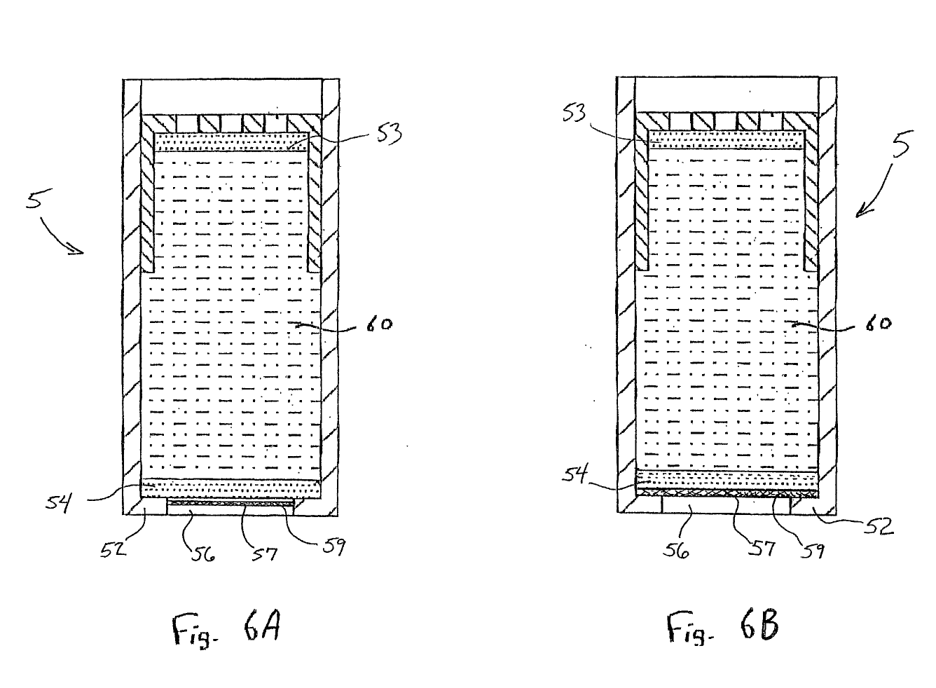

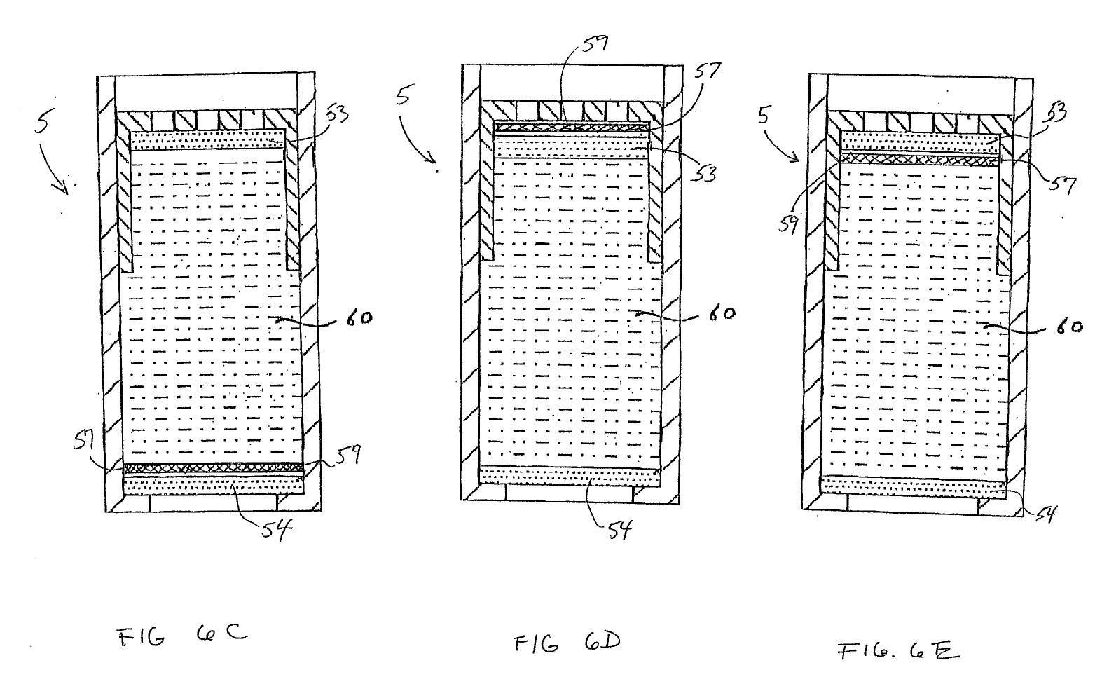

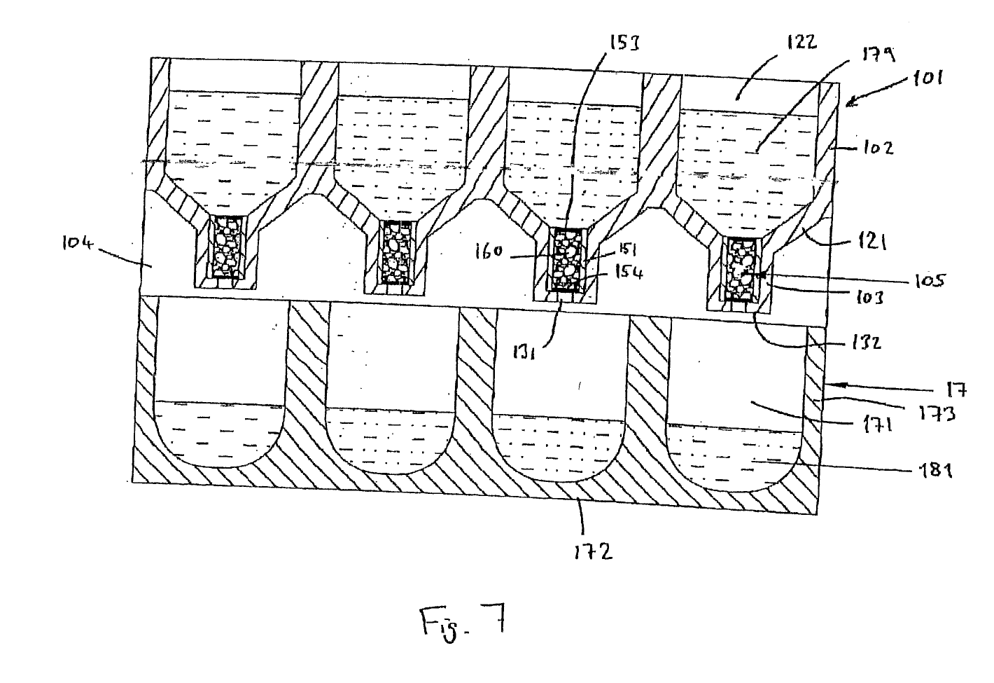

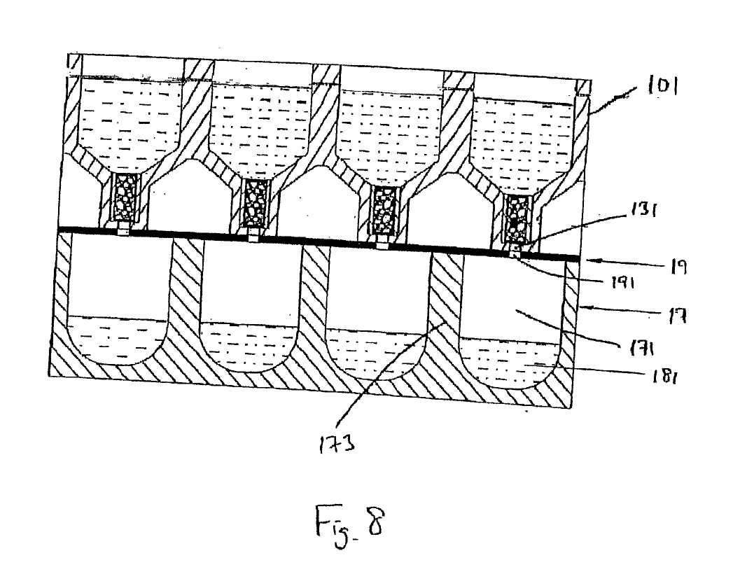

FIGS. 5 and 6, show a mode of preparation of the column module 5. Using conventional assembly line techniques, a series of cylindrical capsule shells 51 may be loaded in turn with respective lower permeable walls 54, a predetermined dose of a slurry 60′ of the chosen particulate medium in a compatible liquid vehicle. The closure plugs 58 are inserted from above. Downward force F is then applied to the top closure 58 at a pressure and for a time chosen to pack the particles of the bed in an optimal way, the liquid vehicle escaping through the lower permeable wall 54 as shown by arrows L. The closure piston 58 is then fixed in position by the tightness of its fit or with a snap engagement, which may be provided by configuration of the outer wall 51. By creating the packed bed using compression of a slurry, the quality of packing is substantially better than with a dry-filled column leading to better separation performance. The volume of the packed resin bed 60 may be about 2 ml.

Resins, typically particulate resins, may be selected from the following options.

1. Ion exchange resins e.g. diethylaminoethyl, quaternary ammonium, sulphonic acid, carboxylic acid.

2. Immobilized lectin affinity resins e.g. with wheat germ agglutinin, concanavalin A, lentil lectin, RCA 1 (Ricinus communis), peanut agglutinin, suitable for glycoprotein and nucleic acid purification.

3. Ni²⁺ or Co²⁺-NTA or IDA IMAC resins, suitable for purification of recombinant proteins. One may also use Cu²⁺, Zn²⁺ and Fe²⁺ types.

4. Protein A, G or L, suitable for antibody purification/handling.

5. Reverse phase media e.g. C2 (ethyl), C4 (butyl), C8 (octyl) and C18 (octadecyl) useful for sample clean-up and for purification of peptides and proteins.

6. Hydrophobic interaction matrices e.g. alkyl (butyl, propyl, octyl) and phenyl-based resins. These can complement the IEX (ion exchange) resins well because proteins eluted in high salt during IEX can be passed directly onto a hydrophobic interaction matrix.

7. Affinity dye resins e.g. Cibacron Blue and Procion, mimetic dye affinity.

8. Hydroxyapatite beads, suitable for protein purification e.g. of plasma proteins.

9. Antibody (immunoaffinity ligands) immobilized resins, suitable for cell separation/isolation.

10. Streptavidin and avidin-derivatized resins which bind particularly to biotin and biotinylated molecules.

11. Protein ligands which can provide purification based on protein-protein

12. Nucleotide and cofactor conjugated resins, e.g. oligo-(dT)-cellulose, poly-(U)-agarose, poly (A)- or nucleotide phosphate-immobilised resins.

13. Boronate affinity resins e.g. for purifying nucleic acids.

14. Activated resins for immobilizing ligands e.g. NHS-activated, CNBr-activated, epoxy-activated, aldehyde-activated, carbonyldiimidazole-activated, bromoacetyl- or iodoacetyl-activated, divinylsulfone-activated, tosyl chloride or tresyl chloride-activated, hydrazide-activated, diazonium-activated, triazine-activated or any photoreactive cross-linker-mediated activated resins.

15. Calmodulin affinity resins for purifying calmodulin-regulated proteins.

16. Gelatin affinity resins e.g. for purifying proteins such as fibronectin.

17. Glutathione resins e.g. for purifying GST fusion proteins.

18. Heparin affinity resins e.g. for purifying proteins such as growth factors, coagulation factors, hormone factors, DNA/RNA polymerases.

19. Amino acid immobilized ligands e.g. lysine, argimine or tryptophan.

20. Synthetic ligands e.g. benzamidine or trifluoromethylketone for affinity-purifying enzymes.

21. Silica.

22. Gel filtration resin.

Depending on the nature and sensitivity of the chromatography medium, removable seals (not shown) may be applied across the top and bottom of the capsule 5. Peelable films e.g. of plastic, foil or plastic/foil composite are suitable for this purpose.

Alternatively, the capsule may be provided to the user empty so that the user may fill it with a customized bed of medium of their own selection or creation. With this user definable capsule, the user completes the steps of loading the medium and or selecting and inserting porous membranes in the capsule, then affixing the removable top closure 58. As mentioned above, the top closure may be affixed by a snap fit onto the capsule, easily accomplished by an end user. Instructions for correctly packing the medium into capsule and implements for carrying out the packing may also be provided together with customisable capsule as a kit.

As shown in FIG. 3, a lid 7 may be provided for the sample holder, fitting into the top opening 24 to isolate the sample chamber 22. The top rim of the sample holder 1 is formed with an outward radial projection 23. This enables the sample holder 1 to fit into the top of a conventional centrifuge tube 8 as shown in FIG. 4, with the protecting rim 23 of the holder 1 engaging the top edge 81 of the centrifuge 8 to suspend the holder 1 inside the tube 8 with the chromatographic bed 60 oriented about half way down and a collection space 82 provided beneath the bed.

The skilled person will appreciate that with a liquid sample for separation contained in the sample chamber 22 (having been clarified or coarse-filtered if necessary) this entire assembly may be put into a centrifuge and spun to drive the sample through the column 60. The entire sample may be eluted in a few minutes, by contrast with conventional gravity laboratory chromatography in which a sample may take a significantly longer time to pass through a chromatography bed.

Absorbed materials are separated from the liquid and from one another in the column. They then can be removed, isolated or separated into fractions according to the situation e.g. by washing through with appropriate solvent. The column module may be removed from the sample holder and processed separately.

A target substance, once eluted from the column, can then be passed through another chromatographic column module or “plug” selected from a kit of such plugs insertable in the same or a similar sample holder. According to the size of the sample to be handled, a user may select sample holders of varying volumes and, for a given volume of sample holder, the user may select an appropriate bed volume according to the expected quantities to be purified. For example, sample holders might be provided at “micro”, “mini” and “maxi” volumes for spin preparations of proteins, with sample chambers of 100 to 500 μl, 20 ml and 70 ml respectively. The micro column may be provided with a single bed volume option (0.02 to 0.1 ml). The mini holder (20 ml sample chamber) may be provided with a choice between bed volumes of 0.2 ml, 0.5 ml and 2 ml, all fittable into the same sample holder socket. The maxi (70 ml) sample chamber can be provided with a choice between 5 ml and 20 ml bed volume “plugs”.

The skilled person will appreciate that although the purification device described is specially adapted for use in a centrifuge, it can also be used for gravity separation, or be connected to a pump or vacuum line as alternative means for speeding flow through the bed.

However, the present design has special virtues when used in a centrifuge. In particular, because of the reduced cross-section of the column insert portion 3 of the sample holder by comparison with the sample chamber 22, relative uniformity of the presentation of the sample to the top of the column bed 60 is much better than if the bed extended right across the sample volume, as shown in FIGS. 4A and 4B. In FIG. 4A, the angle of the convergent wall portion 21 is selected (at about 30° in this embodiment) to avoid trapping of part of the sample 16, whether the device is used in a fixed angle or in a swing tube centrifuge with a force 14 being applied to the sample therein. The angle of the taper serves to funnel the sample 16 into the column bed 60. Additionally, the reduced cross-section helps ensure that the entire surface of the column bed is covered with the sample substance. The reduced cross-section also increases the depth of the chromatography bed 60 through which the sample passes, which makes more efficient use of costly chromatography medium. The increased depth of the medium increases the time a sample spends in contact with the medium as it passes through its increased thickness. The increased exposure to the medium increases the efficiency of the binding process.

By comparison, as shown in FIG. 4B, a conventional sample holder 300 with a column bed 60 of a cross-section equal to that of the sample chamber can be inefficient when used in a centrifuge with prevailing centrifugal force 14. The sample 16 is driven to the side wall and one corner 302 of the column bed. No angled sidewalls are present o help funnel the sample across the surface of the column bed 60. The opposite corner 304 of the column bed remains untouched by the sample 16 and the medium there is wasted. The corner 302 of the medium that is in contact with the sample becomes overloaded and bind inefficiently with risk that some of the sample will be forced by the medium without binding. Additionally, filling the entire cross-section of the column bed in holder 300 with medium, to the proper depth uses more medium than the column bed of holder 1 in FIG. 4A.

In another embodiment of the column module shown in FIGS. 6A through 6E, a flow regulator 57 additionally may be provided to regulate the flow rate of a sample passing through the column module 5 in order to optimize filtration performance. In some situations slowing the flow rate helps the fluid in the module and the attracting components of the filtrate bind together, if the binding kinetics of the sample and the active chromatography support are relatively slow. The flow regulator 57 may comprise an additional filtering membrane 59 positioned along the flow path of sample material through the column module. However, it is emphasized that the flow regulator is an optional component that is not necessary for the intended function of the inventive purification device. The addition of the flow regulator is presented as option for improving the filtering efficiency of the device when separation of certain components is desired.

As mentioned above, the flow regulator may be positioned anywhere along the flow pathway of sample material passing through the column module. For example, the flow regulator may be positioned above or below either the lower permeable wall 54 or the top permeable wall 53. If placed adjacent the lower permeable wall, a disk shaped membrane 59 may have an outside diameter sized to provide an interference fit with the interior wall of a circular outlet opening 56 as shown in FIG. 6A. Alternatively, the membrane 59 may be positioned beneath the lower permeable wall 54 but above and supported by the support flange 52, as shown in FIG. 6B. FIG. 6C shows the placement of the membrane 59 immediately above the lower permeable wall 54. FIG. 6D shows the membrane 59 positioned above top permeable wall 53 and FIG. 6E shows the membrane 59 positioned below the top permeable wall. In the figures a small gap is shown between the permeable wall and the membrane 59 for illustration purposes only. The membrane 59 may be positioned in contact with the permeable wall and secured by a friction fit. Additionally, it should be recognized that the flow regulator membrane 59 may be used in place of either the top permeable wall 53 or lower permeable wall 54 of the column module 5. In use as a permeable wall, the flow regulator membrane can be made of woven polyester, woven PTFE, woven polypropylene and any other woven textile material. Polypropylene, high density polyethylene, ultra high molecular weight polyethylene and ceramic with pore sizes between 1 μm to 400 μm (thicknesses from 0.5 mm to 10 mm) also can be used.

A micro-porous membrane or an ultrafiltration membrane may be used as the filtering membrane 59 serving as the flow regulator 57. For example, a micro-porous membrane may be obtained in a variety of porosity sizes such as 0.1, 0.2, 0.45 and 1.0 micron. Ultrafiltration membranes made of polysulphone, polyethersulphone, regenerated cellulose, cellulose acetate, cellulose tri-acetate, mixed cellulose esters or ceramics may be used. Their molecular weight cut off is between 1 kDa (for low molecular weight molecules e.g. peptides, organics) to 1000 kDa for large proteins, macromolecular complexes, particulates).

Alternatively, microfiltration membranes made of cellulose, cellulose acetate, regenerated cellulose, nitrocellulose, polyethersulphone, polysulphone, ceramic, polypropylene, polyethylene, paper may also be used. Their pore size is between 1 micron and 50 microns. These microfiltration membranes have been shown to slow the flow rate and therefore increase the capture efficiency of the column module with certain resin chemistries (e.g. Protein A, Protein G).

In experimentation, improved efficiency in the separation of certain substances by additionally employing the flow regulator has been suggested. In a column module configured to recover human immunoglobulin (IgG) from Protein A and Protein G, an increase in the amount of IgG collected of approximately 25% was observed in using a column module with a 0.1 micron flow regulator membrane than with the same system without the membrane. The increased effectiveness in filtering in this particular situation is believed to be the result of slowing down the flow rate of material through the column module. It is believed that the slower flow rate was beneficial in this example because the binding kinetics of Protein A and Protein G are relatively slow. The flow rate achieved in this example using a 0.1 micron porosity membrane was 1 ml per minute at a force of 500× G in a swing bucket rotor centrifuge. This example is provided only to illustrate the effect a flow regulator can have in the purification of a sample. Of course other filter membranes could be used as a flow regulator to achieve different flow rates as may be appropriate for the target species in the sample. For example, the regulator filter membrane could be configured to further slow the flow rate of samples containing target species of smaller molecular weight than antibodies captured by Protein A or G.

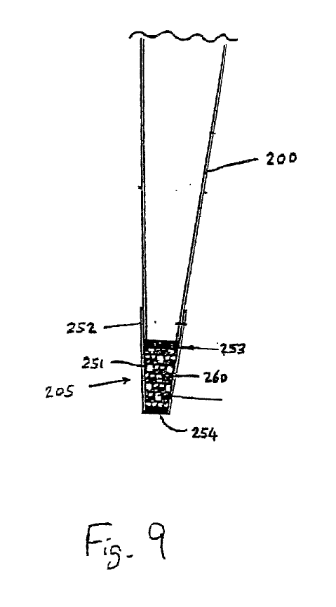

FIG. 7 shows a further embodiment in which a one-piece moulded plastic well plate 101 has its wells 122 formed as respective sample chambers leading down to narrower column insert portions 103 with outlet openings 131 at the bottom. In each socket connector 103 a column module 105 is firmly fitted. These column modules, as in the previous embodiment, consist of a bed of particulate packing medium 160 contained in a cylindrical plastic capsule 151 having permeable end frits or sinters 153, 154 at top and bottom. A difference from the previous embodiment is that the sample holders and column modules are smaller. Thus, the volume of the beds 160 may be e.g. about 20:I as compared to the sample chamber volume. FIG. 7 shows only four sample wells 122 for simplicity, but the actual embodiment may have 96 wells (provided as twelve rows of eight) or 384 wells, as with conventional well plates used with automated or manual pipettes.

The sample well plate 101 sits over a collection tray 17 which has a collection well or vessel 171 for each sample holder 122 and column 105 above. The collection tray 17 also may be formed as a one-piece plastic component, moulded to form the wells 171 defined by upstanding walls 173 in between. The sample well plate 101 rests securely on top of the collector tray 17 through a downwardly-extending peripheral wall 104. The skilled person will readily appreciate how samples 179 pipetted into the sample chambers 122 will elute through the tiny column modules 105 and the filtrate or eluate collect in the respective collection well 171 beneath.

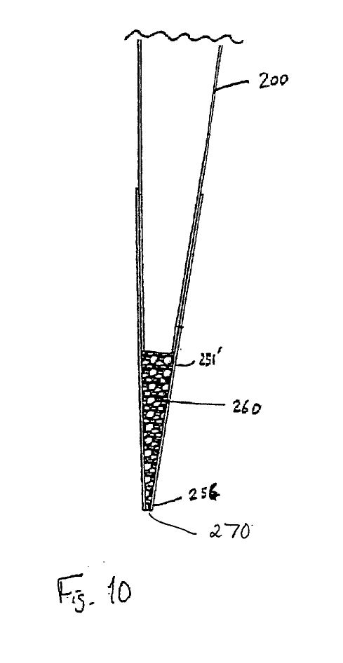

FIG. 8 shows a slightly more sophisticated system in which the sample well plate 101 and collection tray 17 are the same as in FIG. 7, but the system is adapted to reduce the likelihood of cross-contamination between wells if the system is disturbed while being put into a centrifuge, or otherwise moved about. To do this, a barrier seal layer 19 of some flexible polymer extends between the well plate and collection tray. The barrier seal layer 19 has a set of perforations 191 in an array corresponding to the positions of the outlet openings 131 of the chromatography columns 105 above. The engagement of the seal layer 19 from above by the chromatogram outlets and from beneath by the upstanding walls 173 between the collection walls 171 prevent inadvertent mixing of neighbouring filtrates 181.

FIG. 9 shows the application of interchangeable preloaded column modules with a pipette tip 200 (shown here only partially, adjacent the nozzle opening). Here the column module 205 comprises a conical sleeve 251 of impermeable material such as plastic. The cone angle between wall and longitudinal axis is about 5 degrees. A plastic, sinter or frit 254 closes off the bottom, narrow end of the sleeve. A bed of particulate medium 260 lies on the bottom frit 254. A top frit 253 is bonded into place against the interior of the capsule wall to hold the bed 260 in compression. The conical outer wall 251 of the capsule extends up beyond the top frit 253 as a divergent extension 252. This column module constitutes a pipette tip adaptor for a pipette tip 200 having substantially the same conical angle at its nozzle. The adaptor extension 252 is sized so that it can be pushed onto the nozzle of the pipette tip and held in place by frictional force, with a little interference. Thereafter, the column may be used by drawing a sample liquid up through it or driving a sample liquid out through it, according to the situation.

It will be understood that a range of column adaptors containing various types of media may be provided, and may be provided in a range of different sizes suitable for different size pipette tips. It will also be noted that the column module might instead be pushed down inside the pipette tip to seat near its opening. The external form shown has the advantage of assuring no dead space below the bed.

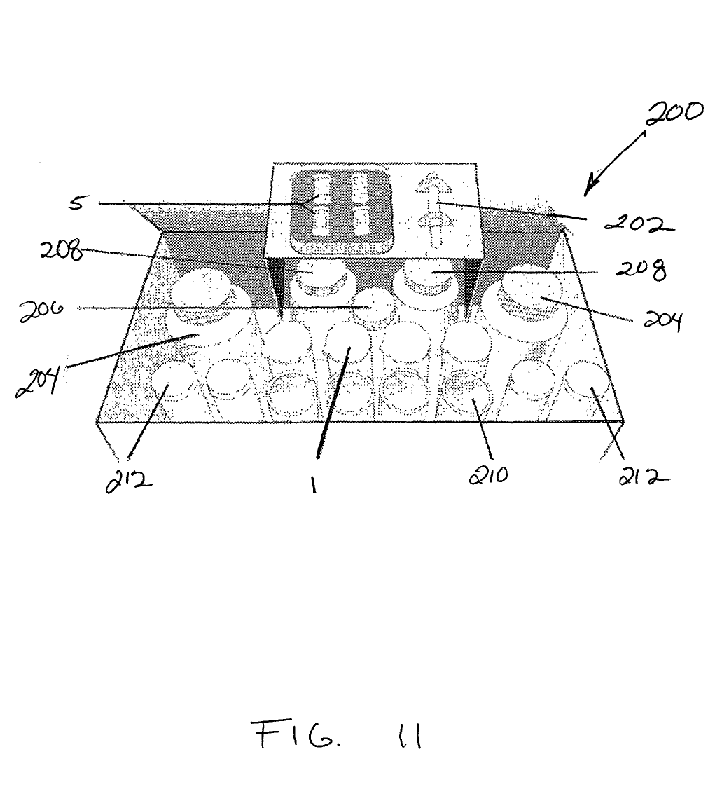

FIG. 10 shows a variant of the FIG. 9 situation with a fine tip pipette. In this example the column module does not use upper and lower frits to hold the particulate medium 260 in place. Instead, the upper surface of the bed is free while the bottom end 256 of the adaptor's capsule 251′ converges to a very fine opening 270 preventing escape of the media particles.

FIG. 11 shows a kit that may be provided to the user of the purification device that provides all necessary devices and materials that would be needed to separate a specific substance from a sample. The kit 200 may include multiple column modules 5, containing the same or different mediums, e.g. particulate medium or membranes, adapted to be securably positioned in the column insert portion at the opening of the sample holder. The kit may also include one or more sample holders 1 to which the column modules are connectable. The kit may also provide an insertion/removal tool 202 to facilitate inserting and removing a column module from the column insert. Also to help facilitate processing of the separated substance, the correct buffers may be provided. Binding buffer 204, neutralization buffer 206 and elution buffer 208 may be provided. Additional centrifuge tubes 210 and ultrafiltration spinners 212 to help prepare the sample may also be provided.

From the foregoing, it should be understood by those skilled in the art that a novel device and method for separating and purifying a substance from a test sample has been disclosed. To increase productivity of the purification process, the device be configured as an array of purification devices configured to correspond to an array of collection chambers on a collection tray into which samples being separated can collect.

It should be understood, however, that the foregoing description of the invention is intended merely to be illustrative thereof and that other modifications, embodiments and equivalents may be apparent to those skilled in the art without departing from its spirit.

1. A purification device comprising:
a sample holder having
a sample chamber in communication through an opening with a a column insert portion.

2. A purification device as defined in claim 1 wherein the column insert portion comprises a cylindrical receptacle extending from an opening of the sample chamber.

3. A purification device as defined in claim 2 wherein the sample holder portion defines a first diameter and first volume and the column insert portion defines a second diameter and second volume that is less than the diameter and volume of the sample holder portion and the opening forms a tapered transition between the sample holder and column insert portion.

4. A purification device as defined in claim 1 further comprising:
a column module configured to be secured in the column insert portion and in communication with the sample holder portion.

5. A purification device as defined in claim 4 wherein the column module further comprises chromatography medium having a special affinity for a given substance.

6. A purification device as defined in claim 1 wherein the column module further comprises permeable membranes configured to contain the medium but permit passage of a sample to through the medium.

7. A purification device as defined in claim 4 wherein a sample flow pathway is defined by the sample chamber, opening and column insert portion and column insert and
a flow regulator positioned along the flow pathway to regulate flow of a sample through the purification device so that purification of the sample is optimized.

8. A purification device as defined in claim 7 wherein the flow regulator comprises an ultrafiltration membrane.

9. A purification device as defined in claim 7 wherein the flow regulator comprises a micro-porous membrane.

10. A purification device as defined in claim 7 wherein the column module further comprises a removable top portion configured to fit in sealing engagement with the column module.

11. A purification device as defined in claim 10 wherein the column module is configured to receive medium selected by a user.

12. A purification device as defined in claim 10 wherein the column module is configured to receive one or more permeable membranes selected by a user.

13. A purification device comprising:
A well plate having a plurality of wells each having a sample chamber portion, a column insert portion; and
a column module insertable into the column insert portion such that it is in fluid communication with the sample chamber portion.

14. A purification device as defined in claim 13 further comprising:
a collection tray configured to correspond to the well plate such that each well of the well plate aligns with a vessel of the collection tray so that samples can be collected.

15 A purification device as defined in claim 14 further comprising:
a barrier seal positioned between the well plate and the collection tray.

16. A purification device as defined in claim 15 wherein the barrier seal is formed from a flexible polymer.

17. A purification device as defined in claim 13 wherein the column module comprises a conical sleeve.

18. A purification device as defined in claim 17 wherein the column module further comprises a bottom sinter and a top sinter and particulate medium contained therebetween.

19. A method of separating a substance from a sample comprising
providing a purification device configured to contain a medium having a special affinity for the given substance,
placing a sample containing at least some amount of the given substance into the purification device,
orienting the purification device so that the sample is forced through the medium and the flow regulator to separate the given substance at flow rate conducive to an intended separation performance.

20. A method as defined in claim 19 wherein the purification device orients the sample above the medium and gravity forces the sample through the medium to separate the protein.

22. A method as defined in claim 19 wherein the purification device loaded with medium and a sample is loaded into a centrifuge such that the sample will be forced through the medium during centrifuge operation.

23. A method as defined in claim 19 further comprising the step of removing the medium with the separated substance from the purification device for further processing.

24. A method as defined in claim 19 wherein the substance to be separated is a protein.

25. A method as defined in claim 19 wherein the purification device comprises a fixture to hold a plurality of samples and mediums to conduct a plurality of separations simultaneously.

26. A method of separating a substance as defined in claim 25 further comprising arranging the fixture over an array of corresponding collection vessels so that samples separated from each purification device travel into a collection vessel.

27. A method of separating a substance as defined in claim 19 further comprising controlling the flow rate of the sample through the medium wit a flow restrictor to optimise binding of the given substance to the medium.

28. A method of separating a given substance from a sample comprising providing a purification device configured to contain a medium having a special affinity for the given substance,
providing a purification device having a customizable column module capsule,
supplying a user definable medium to be placed in the column module,
placing a sample containing at least some amount of the given substance into the purification device,
orienting the purification device so that the sample is forced through the medium to separate the given substance.

29. A method of separating a substance from a sample comprising:
providing a purification device having a sample holder portion and a column insert portion;
providing at least one column module having an affinity for a substance;
selecting a column module having an affinity for the substance desired to be separated from the sample;
placing the column module into the column insert portion of the purification device;
placing a sample containing some amount of the desired substance into the sample holder portion of the purification device;
orienting the purification device to force the sample through the column module to separate the desired substance.

31. A purification device kit comprising:
at least one sample holder having
a sample chamber in communication through an opening with a a column insert portion.
at least one column module insertable into the column insert;
a binding buffer,
an elution buffer, and
a neutralization buffer.

32. A purification device kit as defined in claim 31 wherein a plurality of column modules are provided and each column module has a special affinity for a unique substance.

33. A purification device kit as defined in claim 32 wherein the column modules have affinities for different proteins.

33. A purification device kit as defined in claim 31 wherein a user definable column module is provided having a removable top and user definable mediums are provided for use with the column modules.

34. A purification device kit as defined in claim 31 further comprising:
a column module insertion and removal tool.
